(19) United States
(12) Patent Application Publication
(10) Pub. No.: US 2026/0038127 A1
(43) Pub. Date: Feb. 5, 2026

(54) METHOD AND SYSTEM FOR FIXED PATTERN DETECTION IN MOTION IMAGES

(71) Applicant: REALTEK SEMICONDUCTOR CORP., HSINCHU (TW)

(72) Inventor: Chung-Ping Yu, HSINCHU (TW)

(21) Appl. No.: 19/287,895

(22) Filed: Aug. 1, 2025

(30) Foreign Application Priority Data
Aug. 2, 2024 (TW) 113128856

(51) Int. Cl. G06T 7/207

(52) U.S. Cl. CPC G06T 7/207

(57) ABSTRACT

A method and a system for fixed pattern detection in motion images are provided. In the method, continuous motion images are obtained, and frames at multi-layer resolutions can be retrieved from the motion images. Multiple fixed patterns in multiple frames at the multi-layer resolutions can be detected based on features of previous and current frames. A first fixed pattern at a higher resolution can be to a lower-resolution fixed pattern, and the lower-resolution fixed pattern is merged with a second fixed pattern at the same lower resolution so as to generate a merged fixed pattern. The merged fixed image at the lower resolution is eroded and converted to a higher-resolution image. A boundary detection process is performed on the higher-resolution image. The first fixed image at the higher resolution is eroded according to a result of boundary detection so as to obtain a clear fixed pattern.

### CROSS-REFERENCE TO RELATED PATENT APPLICATION

This application claims the benefit of priority to Taiwan Patent Application No. 113128856, filed on Aug. 2, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for detecting a fixed pattern in motion images, and more particularly to a method and a system that can acquire a clear fixed pattern based on frame image features in multi-layer resolutions.

### BACKGROUND OF THE DISCLOSURE

In a development process of a display, one of the most important objectives is to improve display effect so as to enhance video-viewing experiences for users. One of the items to be improved for the display effect is to improve video smoothness and clarity. A conventional approach for improving the display effect is to compensate motion images of the video through a motion estimation and motion compensation (MEMC) technology, so that the motion images can be displayed more smoothly when the video is played.

FIG. 1 is a schematic diagram illustrating a concept for operating the motion estimation and motion compensation technology. The diagram shows two consecutive frame images which are schematically represented as an (N−1)th frame 101 and an Nth frame 102 of the video. A moving object 100 is found at different positions in the previous frame and in the following frame. An operating principle of the motion estimation and motion compensation technology is to acquire correlation of the moving object 100 in the motion images. As shown in the diagram, a motion vector of the object 100 from the (N−1)th frame 101 to Nth frame 102 can be calculated by a computation circuit based on the positions of the object in the previous frame and the following frame. Next, an image interpolation method is incorporated to interpolate one or more compensation images 105 in-between the (N−1)th frame 101 and Nth 102 according to the motion vector of the object 100. One of the compensation images 105 is such as an interpolation object 100′. Thus, the motion estimation and motion compensation technology can be used to increase frame rate of the video, in which the interpolation object 100′ rendered for the moving object 100 allows the video to be played more smoothly.

However, the motion estimation and motion compensation technology is limited in a range for processing the moving object based on a computing power of the computation circuit, and an error may occur if the moving object is beyond the range limited by the computing power. On the contrary, the fixed pattern present in the image needs to be protected, or the fixed pattern becomes unstable due to misjudgment made by the motion estimation and motion compensation technology. The unstable condition of the fixed pattern is such as a stickiness between the fixed pattern and a background image or a boundary halo of the fixed pattern.

For example, when a video player of the display plays a streaming video downloaded from a streaming platform, a hardware computer and detection software installed in the video player can be used to detect logo images in the streaming video. One of the purposes of logo detection is to separate the fixed images from the streaming video, so that situations such as the fixed images being affected due to the processes of motion estimation and motion compensation can be avoided.

Nevertheless, the conventional logo detection technology may encounter a problem that the detected logo pattern is too wide and exceeds a range of the original logo pattern due to the pattern having too low resolution, or the problem that the portion inside a boundary of the logo pattern is wrongly determined as not being the logo when an edge-detection method is performed thereon, which may cause the logo pattern to drift when the logo pattern is processed by a motion compensation process.

### SUMMARY OF THE DISCLOSURE

For overcoming the problem that the conventional technology fails to properly handle a fixed pattern in motion images when motion estimation and motion compensation (MEMC) are performed on the motion images, provided in the present disclosure is a method for fixed pattern detection in motion images and a system.

In the method for fixed pattern detection in motion images, motion images are obtained, and multi-layer resolution frame images are retrieved from the motion images. Multiple fixed patterns can be detected from multi-layer resolution frame images according to features of the preceding and following frame images. The multiple fixed patterns at least include a first fixed pattern with a higher resolution (defined as a first resolution) and a second fixed pattern with a lower resolution (defined as a second resolution). The first fixed pattern with the higher resolution (i.e., the first resolution) is converted to a converted fixed pattern with a lower resolution (i.e., the second resolution). The converted fixed pattern and the second fixed pattern have the same lower resolution (i.e., the second resolution) and can be merged to a merged fixed pattern. After that, the merged fixed pattern with the second resolution is eroded and then converted into an eroded merged fixed pattern that is configured to have a higher resolution (i.e., the first resolution). A first fixed pattern with the first resolution is eroded according to a result of boundary detection of the fixed pattern so as to obtain a clear fixed pattern.

Further, in the step of detecting the multiple fixed patterns in the multi-layer resolution frame images, a matrix scan window is used to scan pixels in each of the frame images so as to detect the fixed patterns in the different resolutions according to a sum of absolute differences between pixel values of the preceding and following frame images.

Further, in the step of detecting multiple fixed patterns in the multi-layer resolution frame images, both the frame images respectively with the highest resolution and the lowest resolution are discarded for the sake of power saving.

Further, the eroded merged fixed pattern can be converted into a fixed pattern having a higher resolution (i.e., the first resolution) by reduplicating pixels. The boundary of the merged fixed pattern having the second resolution can be detected according to a gradient variation of the inside pixels.

After that, the merged fixed pattern with the second resolution can be eroded by performing image processing to remove boundary pixels of the merged fixed pattern. In the multi-layer resolution frame images obtained from the motion images, when the merged fixed pattern with the second resolution is eroded, the merged fixed pattern in a resolution lower than the second resolution is obtained from an even lower resolution layer, and the merged fixed pattern is then converted into another merged fixed pattern with the second resolution. The merged fixed pattern with the second resolution is then eroded according to a result of boundary detection of the fixed pattern.

In an aspect, after the clear fixed pattern is obtained, the motion images are processed through motion estimation and motion compensation based on the clear fixed pattern for the purpose of increasing a frame rate of the motion images. Further, when the clear fixed pattern is obtained, the flags of the pixels that are determined to be the clear fixed pattern in each of frames are set to be “1”, and the flags are stored into a memory. When the motion images are processed through motion estimation and motion compensation, the pixels with the flags of “1” can be ignored according to the records of the memory.

Still further, when the flags of the pixels of the clear fixed pattern in each of the frames are set, the historical records stored in the memory are referred to for evaluating confidences of the clear fixed patterns.

### BRIEF DESCRIPTION OF THE DRAWINGS

The described embodiments may be better understood by reference to the following description and the accompanying drawings, in which:

FIG. 1 is a schematic diagram illustrating a technical concept of conventional motion estimation and motion compensation technology;

FIG. 2 is a schematic diagram showing motion images including a logo pattern according to one embodiment of the present disclosure;

FIG. 3 is a schematic diagram depicting a halo phenomenon formed through motion estimation and motion compensation performed on the logo pattern in the motion images;

FIG. 4 is a schematic diagram depicting a hollow phenomenon formed through motion estimation and motion compensation performed on the logo pattern in the motion images;

FIG. 5 is a schematic diagram illustrating a system for fixed pattern detection according to one embodiment of the present disclosure;

FIG. 6 is a schematic diagram showing flags of a fixed pattern in an image according to one embodiment of the present disclosure;

FIG. 7 is a schematic diagram illustrating a framework of the system for motion estimation and motion compensation according to one embodiment of the present disclosure;

FIG. 8 is a block diagram depicting merging a fixed pattern with images with multi-layer resolutions according to one embodiment of the present disclosure;

FIG. 9 is a block diagram depicting fixed pattern boundary processing on the images with multi-layer resolutions according to one embodiment of the present disclosure;

FIG. 10 is a flowchart illustrating a method for fixed pattern detection in motion images according to one embodiment of the present disclosure;

FIG. 11 is a schematic diagram illustrating a method for processing the fixed pattern on the images with multi-layer resolutions according to one embodiment of the present disclosure; and

FIG. 12 is an exemplary example of calculating a sum of absolute differences.

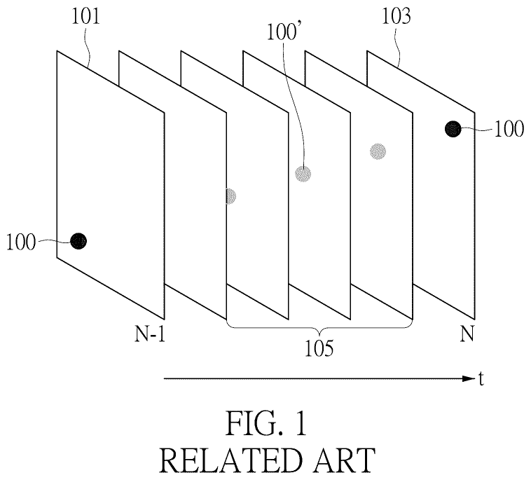

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a method for fixed pattern detection in motion images and a system. The method operated in the system that is configured to process image data. The system can be a circuit system inside a display device that is used to display a streaming video. One of the technical objectives of the method is to resolve a problem that a fixed pattern is improperly processed when the circuit system processes the motion images to enhance a frame rate of the images through motion estimation and motion compensation (MEMC). For example, when the motion images are the images with a lower resolution (defined as a second resolution, e.g., 240*135 pixels images), a fixed pattern (such as a logo pattern) may form a halo that causes a sticking phenomenon between a background image and the logo pattern; when the motion images are the images in a higher resolution (defined as a first resolution, e.g., 480*270 pixels or higher images) that are processed through motion estimation and motion compensation, although the logo pattern has less halo, holes may be formed in the portion within a boundary of the logo pattern.

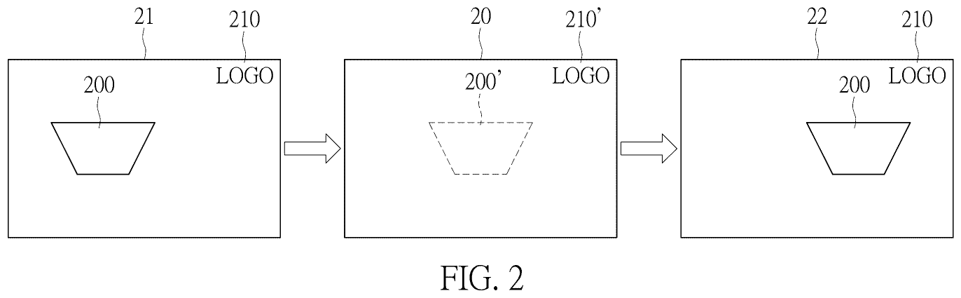

FIG. 2 is an exemplary example of motion images having a logo pattern. Both a first frame 21 and a second frame 22 of the motion images include a moving object 200 and a fixed logo pattern 210. When the motion images are processed through motion estimation and motion compensation, an interpolation frame 20 is generated by performing interpolation based on a motion vector of the moving object 200, and an interpolation object 200′ is formed in the interpolation frame 20 that still includes a fixed logo pattern 210′ (LOGO) through compensation.

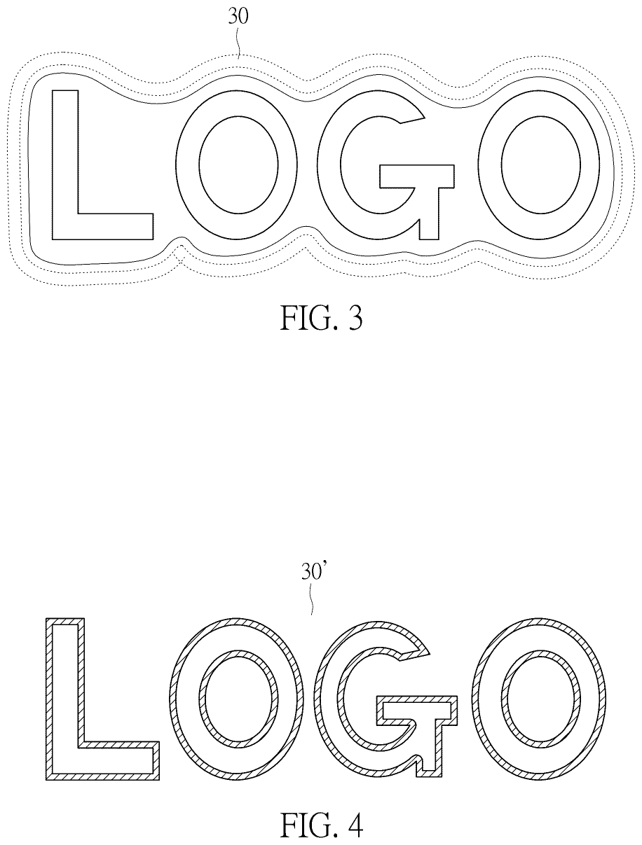

When the motion images are processed through motion estimation and motion compensation, the fixed pattern (such as the logo pattern 200 “LOGO” at an upper right corner of the frame shown in FIG. 2) may form a halo phenomenon due to a resolution being too low. Reference is made to FIG. 3, which is a schematic diagram depicting a halo image to be formed around a logo pattern 30 (LOGO). If the motion estimation and motion compensation are used to process high resolution images, the boundary of the logo pattern can be found by an edge detection technology. However, such as a logo pattern 30′ schematically shown in FIG. 4, some hollow holes that are determined not to be the logo pattern 30′ are formed within the boundary of the logo pattern 30′ (LOGO), and the portions within the boundary of the logo pattern 30′ will be filled with a background image through motion compensation.

For solving the above problems, the method for fixed pattern detection in motion images adopts multi-layer resolutions images to detect a fixed pattern in motion images. The problems caused on the fixed pattern in low resolution images or in high resolution images can be effectively improved by performing motion estimation and motion compensation after coverage of the fixed pattern is confirmed.

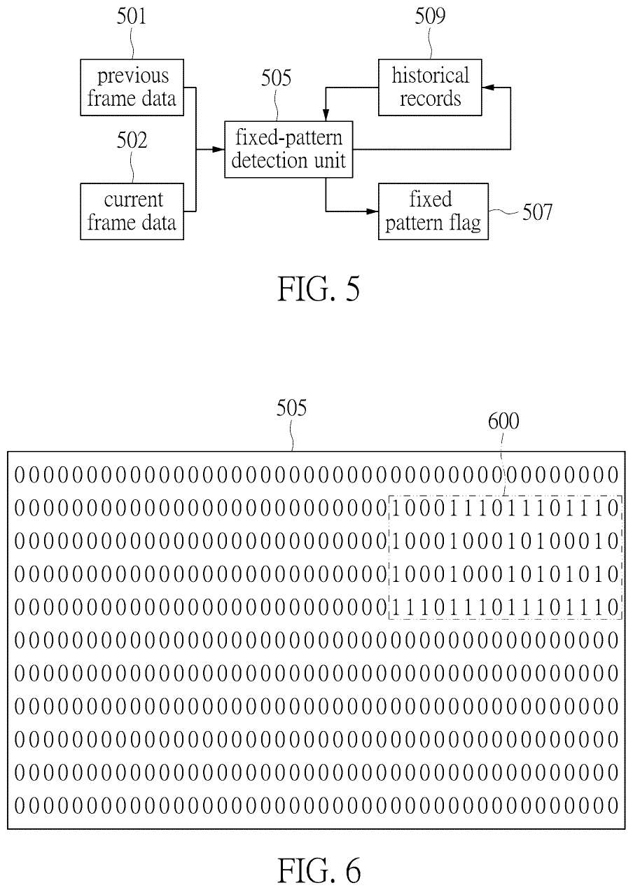

Reference is made to FIG. 5, which is a schematic diagram illustrating a system for fixed pattern detection in motion images according to one embodiment of the present disclosure. The system can be a circuit system that is used to process image data. The circuit system can be a circuitry or a module including a processing circuit disposed in an image-processing device of a television. The circuit system performs the method for fixed pattern detection in motion images through firmware.

After the system shown in the diagram receives motion images, a previous frame data 501 and a current frame data 502 are firstly retrieved. A fixed pattern detection unit 505 that is implemented by software or firmware relies on features of the preceding and following frame images to determine one or more fixed patterns in the motion images. It should be noted that, based on a hardware computing power of the system, multiple fixed patterns can be detected from multi-layer resolution frame images simultaneously or in a time-division manner.

For example, the fixed pattern detection unit 505 can adopt a Sobel operator to detect boundary features of the previous frame data 501 and the current frame data 502. The Sobel operator uses scanning windows in different sizes to retrieve boundary information (e.g., pixel gradient variation) along various directions in each of the images. After any boundary is confirmed, the boundaries in the two frames are compared so as to determine the one or more fixed patterns.

After that, the fixed pattern detection unit 505 labels the pixels that are determined as part of the one or more fixed patterns so as to form fixed pattern flags 507. In the process of labeling the pixels, historical records 509 can also be referred to for confirming the positions of the one or more fixed patterns. According to one embodiment, the historical records 509 are the records stored in a memory of the pixels that were determined as the fixed patterns in the past. The historical records 509 are referred to for determining the positions of the fixed patterns (e.g., the logo patterns) usually in the motion images, and by which a credibility of the fixed pattern to be determined can be evaluated.

Reference is made to FIG. 6, which is a schematic diagram depicting the fixed pattern flag 507 in one embodiment of the present disclosure. A fixed pattern detection technology is used to obtain a region having a fixed pattern 600 in a frame 60. The fixed pattern 600 in the motion images is then confirmed. The pixels of the determined fixed pattern 600 can be labeled as flag “1” (Flag=1). Thus, these pixels labeled as flag “1” can be ignored when motion estimation and motion compensation are performed on the frame 60. As described above, in the process of setting the flags of the pixels of a clear fixed pattern in each of the frames, the historical records stored in the memory can be referred to for evaluating the credibility of the clear fixed pattern.

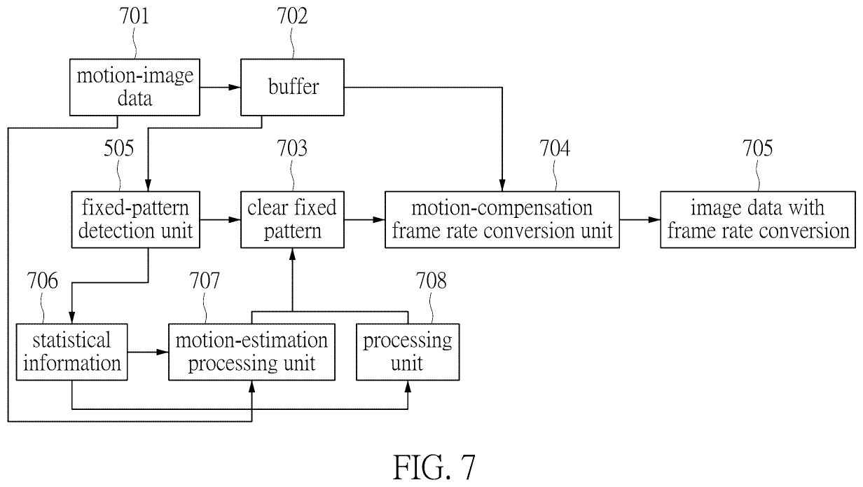

Further, the fixed pattern detection unit 505 that is used to detect the fixed pattern can be operated in the system for operating motion estimation and motion compensation through software or firmware. Reference is made to FIG. 7, which is a schematic diagram illustrating the system for operating motion estimation and motion compensation according to one embodiment of the present disclosure.

The fixed pattern detection unit 505 can be firmware disposed in the circuit system or software used for fixed pattern detection performed in the circuit system. When the fixed pattern detection unit 505 receives a motion-image data 701 from an image source, besides performing fixed pattern detection, the motion-image data 701 is firstly stored in a buffer 702.

The fixed pattern detection unit 505 is mainly used to determine the fixed patterns by comparing the continuous preceding and following frame images in the motion images. The fixed pattern is such as a logo pattern that is a fixed image when playing the motion images. One of the methods for detecting the fixed pattern is to design a matrix scan window (e.g., 3*3 pixels matrix) used to scan pixel values in each of the frame images. The fixed patterns in the different resolutions can be detected according to a sum of absolute differences (SAD) between pixel values of the preceding and following frame images. It should be noted that historical records stored in a memory of the system are referred to for obtaining the positions where the fixed images frequently appear. The system can only use the matrix scan window to scan the positions where the clear fixed patterns frequently appear.

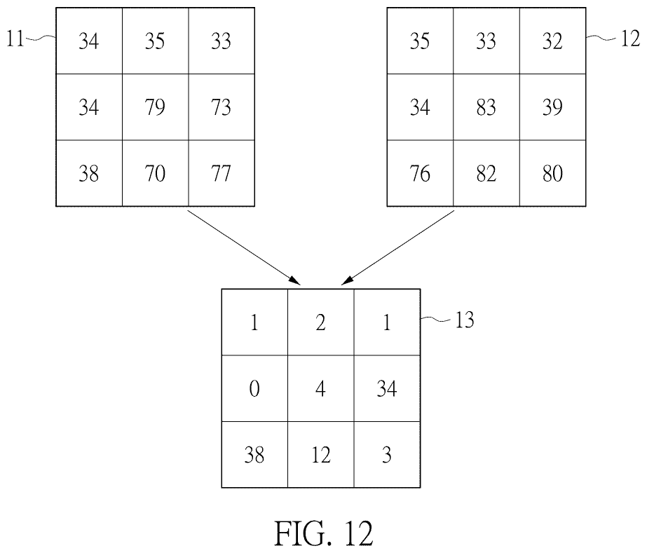

Reference is made to FIG. 12, which is an exemplary diagram of calculating the sum of absolute differences according to the pixel values of each of the frame images. The matrix scan window shown in the diagram is used to scan a preceding frame so as to obtain pixel values of a first window 11, and scan a current frame so as to obtain pixel values of a second window 12. The pixel values at corresponding positions of the preceding and following frames within the matrix scan window 11 are subtracted, and then an absolute value of a subtraction value is calculated. Finally, an absolute difference shown within a third window 13 is obtained.

Afterwards, the absolute differences shown within the third window 13 are added. In the exemplary example shown in the diagram, a sum of absolute differences (SAD) is 95 (i.e., 1+2+1+0+4+34+38+12+3-95). The SAD is compared with a threshold set by the system. For example, a quantity of pixels belonging to the fixed pattern is counted. The pixels are determined as part of the fixed pattern if the quantity is larger than a quantity threshold. Accordingly, it can be evaluated whether or not the window contains the features of the fixed pattern. The pixels may be excluded and no subsequent processing is required if the quantity of the pixels belonging to the fixed pattern does not reach the threshold. Therefore, the computing power of the system can be saved.

Further, after the fixed pattern detection unit 505 obtains the fixed pattern, the pixel values of the fixed pattern are counted so as to obtain statistical information 706. The statistical information 706 is provided to a processing unit 708 of the system and can be the historical records being referred to for confirming the fixed pattern.

When the fixed pattern detection unit 505 detects the fixed pattern from the motion-image data 701, a process for clarifying a clear fixed pattern 703 is performed. Information that is obtained by a motion-estimation processing unit 707 which performs motion estimation on continuous frames of the motion-image data 701 and information that is obtained by the processing unit 708 based on the historical records are referred to for obtaining the clear fixed pattern 703 by a method for processing the fixed pattern in multi-layer resolutions. The method can eliminate the halo phenomenon caused by motion compensation performed on the fixed pattern with a resolution being too low, the problem of misjudging a moving object as the fixed pattern due to the image having a resolution that is too low or insufficient, or the problem of holes within the boundary of the fixed pattern due to the image having a resolution that is too high. When the clear fixed pattern is obtained, the clear fixed pattern is outputted to a motion-compensation frame rate conversion unit 704 for motion compensation. In one embodiment of the present disclosure, one or more compensated images are inserted between two continuous frames in the motion images based on the moving object, so that the frame rate can be raised for obtaining smoother motion images. Further, the portion of determined fixed pattern can be excluded when the compensated images are inserted so as to retain the clear fixed pattern 703 that is obtained by the fixed pattern detection unit 505. Finally, an image data that undergoes frame rate conversion 705 is outputted.

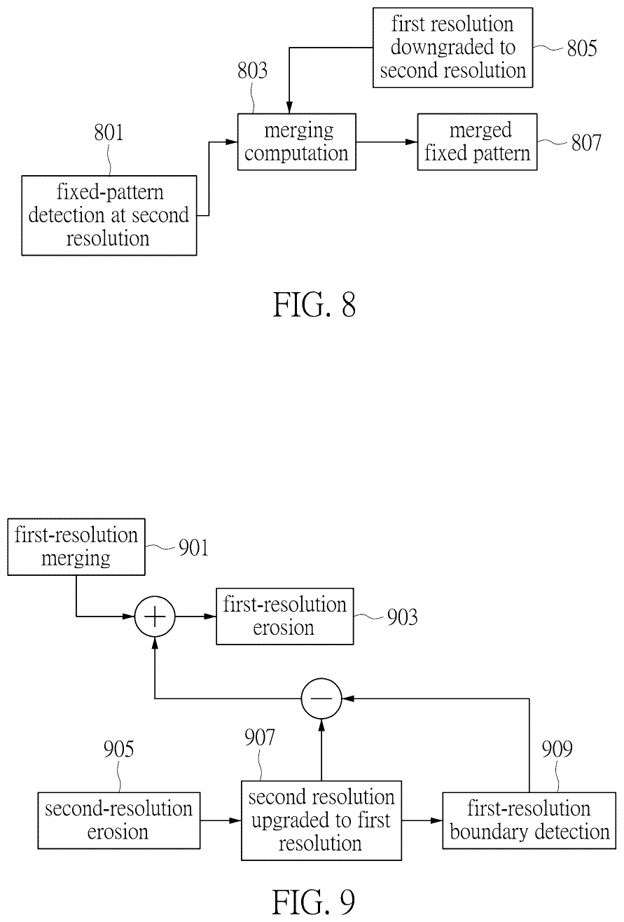

In view of the shortcomings of the conventional technologies, since the fixed pattern in the motion images may have different sizes and resolutions, the method for fixed pattern detection performed by the circuit system processes the images in multi-layer resolutions for obtaining a clear fixed pattern. References are made to FIG. 8 that is a schematic diagram illustrating merging the fixed patterns in different layers of resolution, and FIG. 9 that is another schematic diagram illustrating processing boundaries of the fixed patterns in different layers of resolutions.

According to the embodiment shown in FIG. 8, multi-layer resolution frame images are retrieved from motion images in the beginning. The fixed pattern detection unit performs fixed pattern detection in a second resolution (801) for obtaining a lower resolution (e.g., 1K) fixed pattern. On the other hand, the fixed pattern in a first resolution, i.e., a higher resolution (e.g., 2K), is downgraded to a fixed pattern in the second resolution (805). Therefore, the two images with the same resolution that is a lower resolution, i.e., the second resolution, are merged by a merging computation (803) so as to obtain a merged fixed pattern (807).

In FIG. 9, when first-resolution merging 901 is performed for obtaining the first resolution fixed pattern, a first fixed pattern with a higher resolution is eroded based on a result of boundary detection of the lower-resolution fixed pattern, so that a clear fixed pattern can be obtained.

In the current example, a second-resolution erosion 905 is performed on the merged fixed pattern in the lower resolution, in which the boundary pixels are removed from the merged fixed pattern by an image-processing process. Afterwards, in the step of second resolution fixed pattern being upgraded to first resolution fixed pattern (907), the eroded merged fixed pattern is converted to the fixed pattern in the higher resolution through reduplicate pixels. A step of first-resolution boundary detection (909) is then performed for detecting the boundary of the merged fixed pattern in the higher resolution according to gradient variation of the pixels. Next, after a boundary-removing operation is performed with a lower resolution (i.e., the second resolution) on the fixed pattern, the system can rejoin the boundary in a higher resolution (i.e., the first resolution). After that, a first-resolution erosion 903 is then performed so as to obtain a clear fixed pattern.

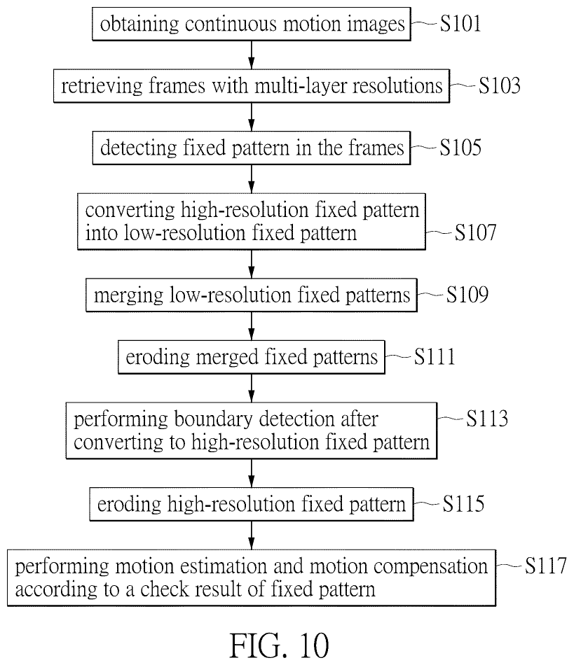

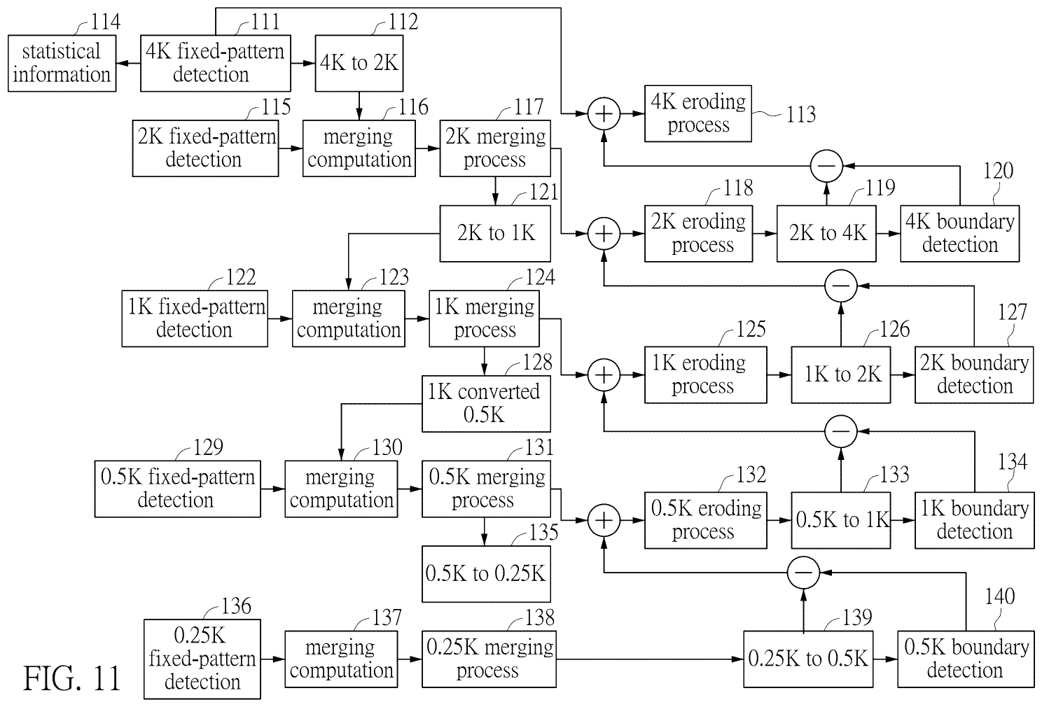

Reference is made to FIG. 10, which shows a flowchart illustrating the method for fixed pattern detection in motion images according to one embodiment of the present disclosure.

In the beginning of the flow, continuous motion images are received (step S101), and multi-layer resolution frame images are obtained by converting the motion images into the frames in multiple resolutions (step S103). Multiple fixed patterns in multiple different resolutions can be detected in the multi-layer resolution frame images (step S105), in which the multiple fixed patterns in the multi-layer resolution frame images can be detected based on the features of preceding and following frame images. One of the methods to detect the fixed patterns is a Sobel operator that is used to search the boundaries based on gradient variations of the pixel values of each of the frames, so that the boundaries of the fixed patterns in various directions (e.g., a vertical direction, a horizontal direction, and an oblique direction) can be searched. The results of the boundaries of the fixed patterns are compared with the image features between the preceding and following frame images so as to confirm the boundaries of the fixed patterns. In an aspect of the method for obtaining the fixed patterns in multi-layer resolutions, at least the first fixed pattern in a higher resolution and the second fixed pattern in a lower resolution are included.

According to the above descriptions of the embodiments, the matrix scan window is used to scan the pixel values of each of the frame images. The sum of absolute differences between the pixel values of the preceding and following frame images is used to detect the fixed patterns in different resolutions. The technical concept of obtaining fixed pattern patterns in multi-layer resolutions is that, for the regions that are scanned each time, even though any fixed pattern is detected in the lower resolution image, it is still not regarded as a fixed pattern if there is not a fixed pattern to be detected in the higher resolution image; even though any fixed pattern is detected in the higher resolution image, it is also not a fixed pattern if there is not fixed pattern to be detected in the lower resolution image.

When the fixed patterns in different resolutions are obtained, the first fixed pattern in a higher resolution can be converted into a converted fixed pattern in a lower resolution (step S107). The converted fixed patterns in the same lower resolution are merged so as to obtain the above-mentioned second fixed pattern that is a merged fixed pattern (step S109). Therefore, the merged fixed pattern in a lower resolution can be processed by an eroding process (step S111).

Next, the eroded merged fixed pattern is converted to a higher resolution fixed pattern. One of the methods to convert the eroded merged fixed pattern to a higher resolution fixed pattern is through a method of reduplicate pixels, and then boundary detection is performed. The boundary of the merged fixed pattern in a higher resolution can be detected according to gradient variations of pixel values (step S113). The first fixed pattern in a higher resolution can be processed by an eroding process according to a result of boundary detection (step S115) so as to obtain a clear fixed pattern. The system then relies on a check result of the clear fixed pattern to perform motion estimation and motion compensation (step S117) for obtaining the clear fixed pattern and increasing a frame rate of the motion images.

In one of the embodiments of the present disclosure, when the system for fixed pattern detection is in operation, in the step S105 of detecting multiple fixed patterns in the multi-layer resolution frame images, the power for operating the system can be saved by ignoring some steps for detecting the fixed patterns, e.g., by discarding the frame images respectively with the highest resolution and the lowest resolution.

It should be noted that, in the method for fixed pattern detection in motion images, when the multi-layer resolution frame images are retrieved from the motion images and the merged fixed patterns in different lower resolutions are eroded, the merged fixed patterns in a resolution lower than the second resolution can be obtained from the merged fixed patterns in an even lower resolution layer. A boundary detection process is performed on the merged fixed patterns in the even lower resolution. The eroding process is performed on the merged fixed patterns in the even lower resolution based on a result of boundary detection. The relevant embodiment can be referred to in FIG. 11, which is a schematic diagram illustrating a method for processing the fixed patterns in multi-layer resolutions according to one embodiment of the present disclosure.

The various resolutions such as 4K, 2K or the like in a following exemplary example are merely used to illustrate one of the aspects of the method for fixed pattern detection in motion images according to one embodiment of the present disclosure.

When the system receives 4K motion images, the images in multi-layer resolutions can also be obtained. The current exemplary example shows that the multi-layer resolutions include 4K, 2K, 1K, 0.5K and 0.25K. The fixed pattern detection can be frame-by-frame performed on the images in multi-layer resolutions. For example, a fixed pattern detection (111) is performed on a 4K video, a fixed pattern detection (115) is performed on a 2K video, a fixed pattern detection (122) is performed on an 1K video, a fixed pattern detection (129) is performed on a 0.5K video, and a fixed pattern detection (136) is performed a 0.25K video. Further, the result of boundary detection of the lower resolution fixed patterns is referred to for performing the eroding process on the fixed patterns in various resolutions.

In the exemplary example shown in the diagram, the fixed pattern detection (111) is firstly performed on the 4K video, and statistical information of the result of the fixed pattern detection (111) forms a historical record (114) and becomes a confidence indicator for subsequent fixed pattern detection. In the meantime, after the 4K fixed pattern is converted to a 2K fixed pattern (112), the 2K fixed pattern is merged with a result of the fixed pattern detection (115) by executing a merging computation (116) so as to form a 2K merged fixed pattern (117).

The fixed pattern detection (111) is performed on the 4K video for obtaining the fixed pattern after an eroding process (118) is performed on a lower resolution (i.e., 2K) image, the lower resolution (i.e., 2K) image is converted to a higher resolution (i.e., 4K) image (119), and boundary detection is performed on the 4K fixed pattern (120). After a boundary-removing operation is performed on a lower resolution (i.e., 2K), the system relies on a result of boundary detection of the 4K image to rejoin the boundary in a higher resolution (i.e., 4K). After that, the eroding process (113) is performed on the 4K image so as to erode the higher resolution image for eliminating redundant peripheral pixels of the fixed pattern.

Accordingly, when the eroding process is performed on the 2K image (118), a result of boundary detection for the fixed pattern in an even lower resolution is also referred to for performing the eroding process.

Next, the merged fixed pattern in 2K resolution (117) is converted into a fixed pattern in a lower resolution (e.g., 1K) (121), and the fixed pattern in a lower resolution is merged with another fixed pattern that is obtained by a fixed pattern detection (122) performed on an image in an 1K resolution through a merging computation (123). Therefore, a merged fixed pattern in 1K resolution is obtained (124).

Afterwards, an eroding process is performed on the fixed pattern in 1K resolution (125), and the fixed pattern is converted into a fixed pattern in a higher resolution, i.e., 1K resolution image is converted into a 2K resolution image (126). Further, boundary detection is performed on the fixed pattern in 2K resolution (127), and the fixed pattern is processed by a boundary-removing operation in a lower resolution (e.g., 1K at this stage). The fixed pattern can be rejoined with the boundary in a higher resolution (e.g., 2K at this stage) according to a result of boundary detection, and then an eroding process is performed on the fixed pattern in 2K resolution (118). Similarly, the eroding process is performed on a fixed pattern in 1K resolution (125) according to a result of boundary detection performed on a fixed pattern in an even lower resolution.

When the merged fixed pattern in 1K resolution is obtained (124), the merged fixed pattern is then down-converted to a fixed pattern in 0.5K resolution (128). The fixed pattern in 0.5K resolution is merged with a fixed pattern in 0.5K resolution that is obtained by fixed pattern detection (129) through a merging computation (130) so as to obtain a merged fixed pattern in 0.5K resolution (131). Similarly, the fixed pattern in 0.5K resolution is performed by an eroding process (132), and the fixed pattern in 0.5K resolution is converted to a fixed pattern in a higher resolution (i.e., 1K resolution) (133). Boundary detection in 1K resolution is performed on the fixed pattern in 1K resolution (134), and a boundary-removing operation in a lower resolution (e.g., 0.5K at this stage) is performed on the fixed pattern in 1K resolution. The fixed pattern in 1K resolution is rejoined with the boundary in a higher resolution (e.g., 1K at this stage) according to a result of boundary detection. Next, an eroding process is performed on the above fixed pattern in 1K resolution (125).

Similarly, a merged fixed pattern is obtained through a merging computation in 0.5K resolution (131), and the merged fixed pattern is down-converted to a fixed pattern in 0.25K resolution (135). The fixed pattern in 0.25K resolution is merged with a fixed pattern in 0.25K resolution that is obtained by fixed pattern detection (136) through a merging computation (137) so as to obtain a merged fixed pattern in 0.25K resolution (138).

The merged fixed pattern in 0.25K resolution is converted to a fixed pattern in a higher resolution (e.g., 0.5K) (139), and boundary detection is performed on the fixed pattern in a higher resolution (e.g., 0.5K) (140). Similarly, a boundary-removing operation is performed on the merged fixed pattern in a lower resolution (i.e., 0.25K at this stage), and is rejoined with a boundary in a higher resolution (i.e., 0.5K at this stage) according to a result of boundary detection. The system then performs an eroding process on the fixed pattern in 0.5K resolution (132).

Thus, for obtaining a clear fixed pattern, the method for fixed pattern detection in motion images of the present disclosure adopts a multi-layer resolution computation for obtaining fixed pattern in different resolutions. Based on the result of the fixed patterns obtained in each of the layers of resolution, conversion computations of the fixed patterns in different resolutions, and the information of boundaries that are detected from the fixed patterns in the lower resolutions, the clear fixed pattern can be finally obtained by performing an eroding process on the fixed patterns in a higher resolution relative to a highest resolution.

In the system for fixed pattern detection in motion images, the pixels of the clear fixed pattern in each of the frames are labeled with flags. For example, the flag is set to “1” for the pixels of the clear fixed pattern in each of the frames. In addition to using the flags as historical records stored in a memory to evaluate credibility of the fixed pattern, the flags are also used to be a reference for avoiding being processed by motion estimation and motion compensation.

Furthermore, the historical records are referred to for determining the regions where the fixed patterns appear more frequently. For example, a general logo pattern may only appear in some specific regions such as four corners of a screen picture, and the fixed pattern detection may only be performed on these regions for saving the computing power.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for fixed pattern detection in motion images, performed in a system, and comprising:
obtaining continuous motion images;
retrieving multi-layer resolution frame images from the motion images;
detecting multiple fixed patterns in the multi-layer resolution frame images of preceding and following frame images, wherein the multi-layer resolution frame images at least include a first fixed pattern with a first resolution and a second fixed pattern with a second resolution relative to the first fixed pattern;
converting the first fixed pattern with the first resolution into a converted fixed pattern in the second resolution, and merging the converted fixed pattern and the second fixed pattern in the second resolution so as to obtain a merged fixed pattern;
eroding the merged fixed pattern in the second resolution;
converting the eroded merged fixed pattern into a fixed pattern in the first resolution and performing boundary detection on the fixed pattern in the first resolution; and
eroding the fixed pattern with the first resolution so as to obtain a clear fixed pattern according to a result of boundary detection.

2. The method according to claim 1, wherein, in the step of detecting the multiple fixed patterns in the multi-layer resolution frame images, a matrix scan window is used to scan pixels in each of the frame images so as to detect the fixed patterns in the different resolutions according to a sum of absolute differences between pixel values of the preceding and following frame images.

3. The method according to claim 2, wherein, in the step of detecting multiple fixed patterns in the multi-layer resolution frame images, both the frame images respectively with highest resolution and lowest resolution are discarded.

4. The method according to claim 1, wherein the eroded merged fixed pattern is converted into the fixed pattern in the first resolution by repeating pixels, and then a boundary of the eroded merged fixed pattern in the first resolution is detected according to gradient changes of the pixel values.

5. The method according to claim 4, wherein the merged fixed pattern with the second resolution is eroded by performing image processing to remove boundary pixels of the merged fixed pattern.

6. The method according to claim 1, wherein, in the multi-layer resolution frame images retrieved from the motion images, when the merged fixed pattern in the second resolution is processed by an eroding process, a merged fixed pattern in a resolution lower than the second resolution is obtained from a layer with an even lower resolution, the merged fixed pattern in a resolution lower than the second resolution is converted to another merged fixed pattern in the second resolution, and the another merged fixed pattern is eroded based on a result of boundary detection.

7. The method according to claim 1, wherein, when the eroded merged fixed pattern is converted to a fixed pattern in the first resolution, after boundary detection is performed, the fixed pattern that is processed with a boundary-removing operation in the second resolution is rejoined with a boundary in the first resolution, and the first fixed pattern in the first resolution is processed by the eroding process.

8. The method according to claim 1, wherein, after the clear fixed pattern is obtained, the motion images are processed by motion estimation and motion compensation by referring to the clear fixed pattern so as to increase a frame rate of the motion images.

9. The method according to claim 8, wherein, when the clear fixed pattern is obtained, the pixels of the clear fixed pattern in the frames are labeled as flag “1” and recorded in a memory, and the pixels having the flag “1” recorded in the memory are ignored when performing motion estimation and motion compensation on the motion images.

10. The method according to claim 9, wherein, in a process of setting flags on pixels of the clear fixed pattern in the frames, historical records stored in a memory of the system are referred to for evaluating credibility of the clear fixed pattern.

11. A system for fixed pattern detection in motion images, comprising:
a processing circuit, used to perform a method for fixed pattern detection in motion images by a firmware, wherein the method comprises:
obtaining continuous motion images;
retrieving multi-layer resolution frame images from the motion images;
detecting multiple fixed patterns in the multi-layer resolution frame images based on preceding and following frame images, wherein the multi-layer resolution frame images at least include a first fixed pattern with a first resolution and a second fixed pattern with a second resolution relative to the first fixed pattern;
converting the first fixed pattern with the first resolution into a converted fixed pattern in the second resolution, and merging the converted fixed pattern and the second fixed pattern in the second resolution so as to obtain a merged fixed pattern;
eroding the merged fixed pattern in the second resolution;
converting the eroded merged fixed pattern into a fixed pattern in the first resolution and performing boundary detection on the fixed pattern in the first resolution; and
eroding the first fixed pattern with the first resolution so as to obtain a clear fixed pattern according to a result of boundary detection.

12. The system according to claim 11, wherein, in the step of detecting the multiple fixed patterns in the multi-layer resolution frame images, a matrix scan window is used to scan pixels in each of the frame images so as to detect the fixed patterns in the different resolutions according to a sum of absolute differences between pixel values of the preceding and following frame images.

13. The system according to claim 12, wherein, in the step of detecting multiple fixed patterns in the multi-layer resolution frame images, both the frame images respectively with highest resolution and lowest resolution are discarded.

14. The system according to claim 12, wherein positions where the clear fixed pattern frequently appears are determined based on historical records, and the processing circuit only uses the matrix scan window to scan the positions where the clear fixed pattern frequently appears.

15. The system according to claim 11, wherein the eroded merged fixed pattern is converted into the fixed pattern in the first resolution by repeating pixels, and then a boundary of the eroded merged fixed pattern in the first resolution is detected according to gradient changes of the pixel values.

16. The system according to claim 15, wherein the merged fixed pattern with the second resolution is eroded by performing image processing to remove boundary pixels of the merged fixed pattern.

17. The system according to claim 11, wherein, when the eroded merged fixed pattern is converted into a fixed pattern with the first resolution, after boundary detection is performed, the fixed pattern is rejoined with the boundary in the first resolution through a boundary-removing operation performed on the fixed pattern in the second resolution, and the first fixed pattern in the first resolution is processed by the eroding process.

18. The system according to claim 11, wherein, when the clear fixed pattern is obtained, the motion images are processed through motion estimation and motion compensation based on the clear fixed pattern so as to increase a frame rate of the motion images.

19. The system according to claim 18, wherein, when the clear fixed pattern is obtained, the pixels of the clear fixed pattern in the frames are labeled as flag “1” and recorded in a memory, and the pixels having the flag “1” recorded in the memory are ignored when performing motion estimation and motion compensation on the motion images.

20. The system according to claim 19, wherein, in a process of setting flags on pixels of the clear fixed pattern in the frames, historical records stored in a memory of the system are referred to for evaluating credibility of the clear fixed pattern.
